(19) United States
(12) Patent Application Publication
(10) Pub. No.: US 2009/0019687 A1
(43) Pub. Date: Jan. 22, 2009

(54) Manufacturing method of planar antenna

(76) Inventor: Chin-Hsiang Tseng, Jhubei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/882,968

(22) Filed: Aug. 8, 2007

(30) Foreign Application Priority Data
Jul. 19, 2007 (TW) 96126367

(51) Int. Cl. H01P 11/00

(52) U.S. Cl. 29/600

(57) ABSTRACT

A manufacturing method of a planar antenna is provided. Wherein, a plurality of antenna patterns and conductive patterns are simultaneously formed by the printing or electroless plating process. The conductive patterns which string the antenna patterns are taken as the plating electrodes and a roll-to-roll manufacturing process is cooperated to plate the antenna patterns. Then, a cutting process is used to separate the electroplated antenna patterns and the conductive patterns to respectively form the individual antenna structure. The manufacturing method has the advantages of speedy manufacture, mass production and low cost.

### BACKGROUND OF THE INVENTION

1. Field of the Invention

The present invention relates to a manufacturing method of an antenna, and more especially, to the manufacturing method of a flexible planar antenna.

2. Background of the Related Art

Because of the progress of the antenna manufacturing technology, various kinds of the antenna manufacturing technology, such as the technology of the etching, the plating, the screen printing, the printing, the imprint or the electroless plating, are adopted by the industry. At present, in the advanced antenna manufacturing process, more than two different manufacturing technologies are combined to produce the antenna. FIG. 1a and FIG. 1b are diagrams illustrating the conventional methods for manufacturing the planar antenna. As shown in FIG. 1a, a plurality of the antenna patterns 12 made of the conductive material are printed on a substrate 10, and then the antenna patterns 12 are soaked in the electrolyte (not shown). Continuously, as shown in FIG. 1b, a plurality of electrode sticks 14 are respectively used to contact with the plurality of the antenna patterns 12, wherein every electrode stick 14 contacts with a portion of every antenna pattern 12, and then the antenna patterns 12 are electroplated by charging the electrode sticks 14.

However, during this electroplating process, the electrode stick is required to soak in the electrolyte again and again, so that the electrode sticks are electroplated with the electrolytic material, too. Therefore, the electrode sticks must be changed or cleaned by using the chemical solution, which not only causes the inconvenient usage, but also increases the pollution and cost due to the use of the chemical solution.

Moreover, just only the region near the contacting portion is electroplated by charging the electrode stick rather than the whole surface of the antenna pattern. The antenna patterns attached to the electrode stick can not be electroplated. With conventional complex steps, a uniform electroplating layer on the every antenna pattern is implemented by repeatedly attaching the electrode stick to various portions of the antenna pattern many times. Besides, the electrode stick may fail in attaching to the respective antenna pattern if the antenna patterns are too close to each other.

### SUMMARY OF THE INVENTION

In order to solve the foregoing problems, one object of this invention is to provide a manufacturing method of a planar antenna, wherein the conductive pattern connecting with the antenna patterns, is formed along with the antenna patterns to be directly taken as the electroplating electrodes, so that all the connected antenna patterns can be electroplated simultaneously by charging the conductive pattern, and so as to decrease the cost of using and cleaning the electrode sticks and further to solve the conventional problem, in which the electrode stick may fail in attaching to the respective antenna pattern if the antenna patterns are too close to each other.

One object of this invention is to provide a manufacturing method of a planar antenna, wherein by the cooperation of the roll-to-roll manufacturing process, the whole electroplating working can be completed by the continuous electroplating processes, so that the non-uniform problem of the electroplating layer caused by the contacts of the electrode sticks can be solved, and so as to have the advantages of speedy manufacture and mass production.

Accordingly, one embodiment of the present invention provides a manufacturing method of a planar antenna, which includes: providing a flexible substrate; forming a plurality of antenna patterns on the flexible substrate and forming a conductive pattern to connect the plurality of antenna patterns, wherein the conductive pattern is electrically connected to an electrode; soaking the flexible substrate in the electrolyte and simultaneously electroplating the plurality of antenna patterns with an electroplating layer by charging the conductive pattern; and cutting parts of the flexible substrate to separate the plurality of antenna patterns from the conductive pattern.

### BRIEF DESCRIPTION OF THE DRAWINGS

FIG. 1a and FIG. 1b are diagrams illustrating a conventional method for manufacturing a planar antenna;

FIG. 2a to FIG. 2e are diagrams illustrating a method for manufacturing a planar antenna in accordance with an embodiment of the present invention;

FIG. 3 is a diagram illustrating the roll-to-roll electroplating process; and

FIG. 4 is a cross-section diagram illustrating one of the antenna structures.

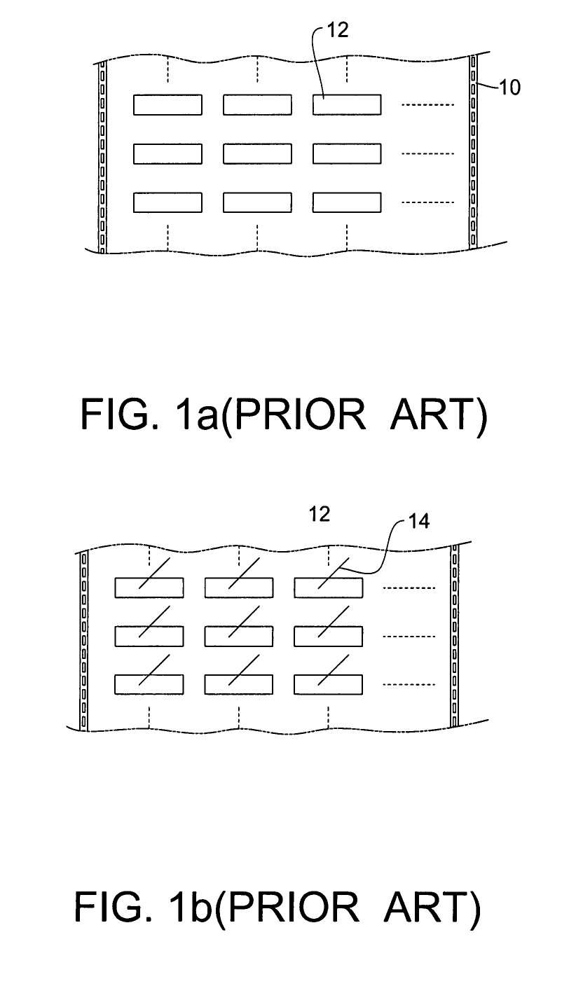

### DETAILED DESCRIPTION OF THE INVENTION

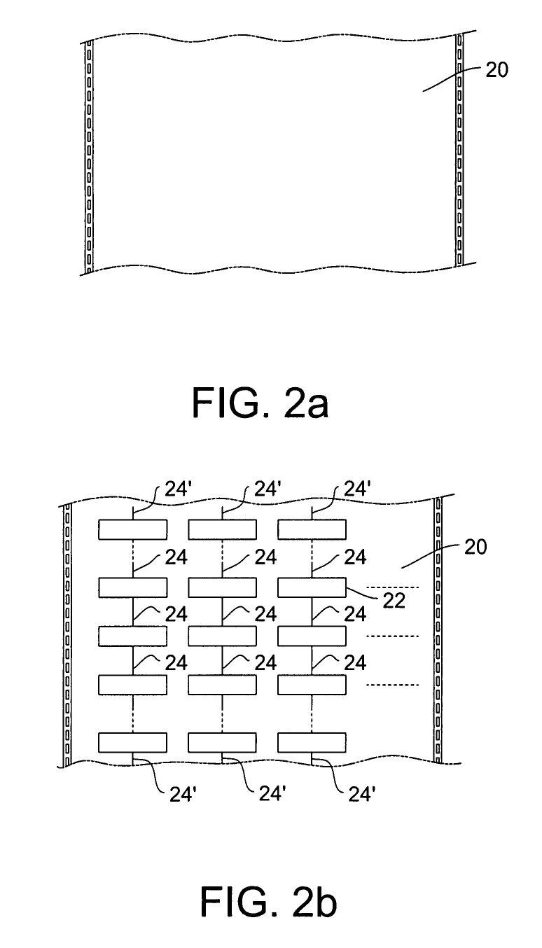

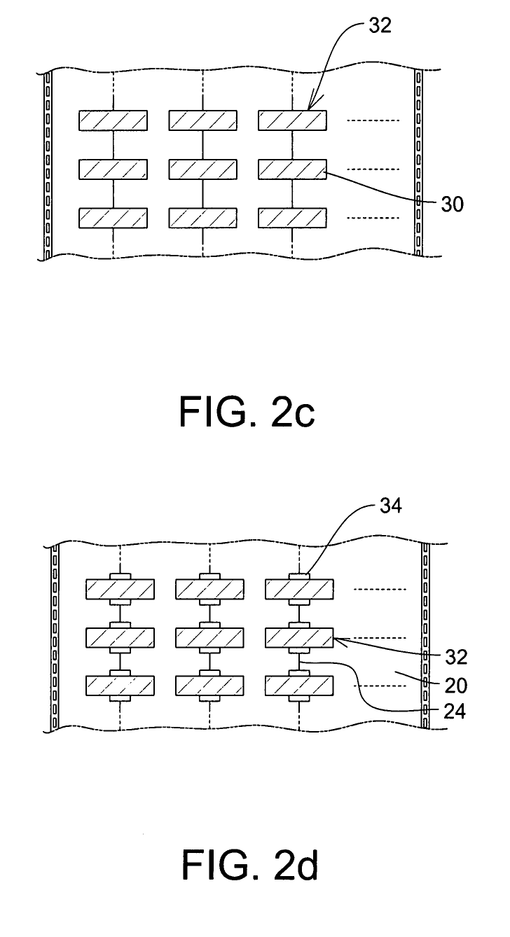

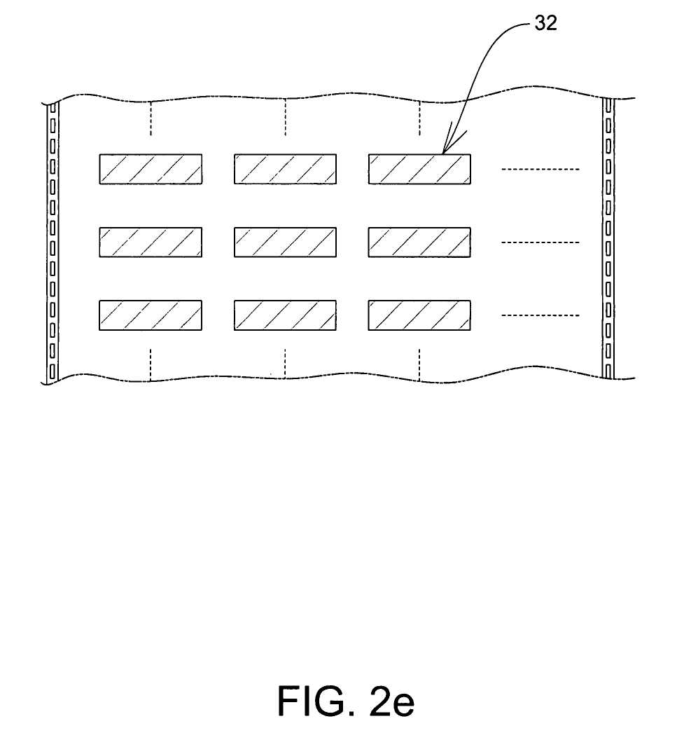

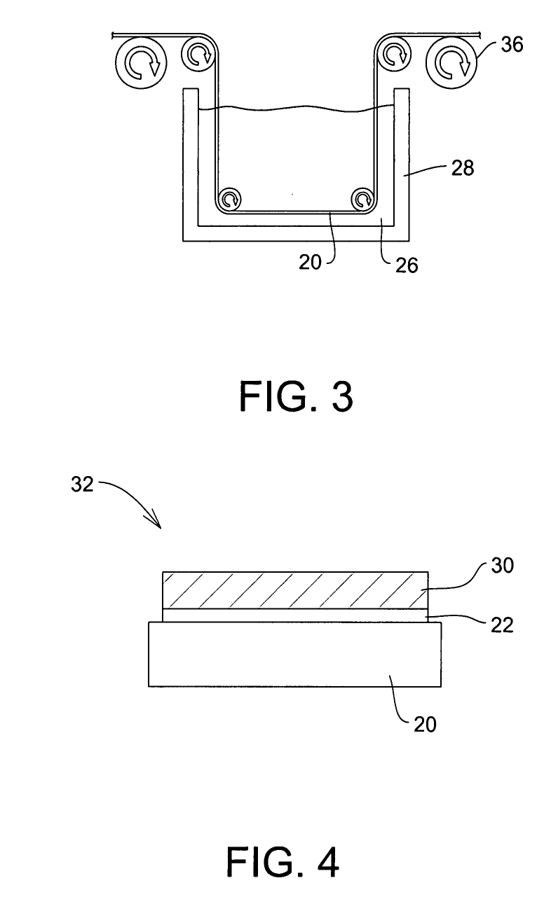

Please refer to FIG. 2a to FIG. 2e are diagrams illustrating the method for manufacturing a planar antenna in accordance with an embodiment of the present invention. As shown in FIG. 2a, a flexible substrate is provided, and the flexible substrate is a roll 20 made of polyester (PET), polyimide (PI) or paper in the present embodiment. A plurality of antenna patterns 22 and a conductive pattern, which are made of a conductive material, are simultaneously printed on the roll 20. As shown in FIG. 2b, the conductive pattern includes a plurality of electroplating lines 24, 24′, and every electroplating line 24 is used to connect two antenna patterns 22, so that all the antenna patterns 22 are connected one by one by using the plurality of electroplating lines 24, to construct an antenna-pattern string. Wherein, by using the electroplating lines 24′, two terminals of the antenna-pattern string are electrically connected to the electrodes (no shown) at two opposite ends of the roll 20. Next, please simultaneously refer to FIG. 3, the roll 20 having the antenna patterns 22 and the electroplating lines 24, 24′ are soaked in an electrolyte 26 in an electrobath 28, and then all the antenna patterns 22 are electroplated by charging all the electroplating lines 24, 24′, and so as to respectively form an electroplating layer 30 on every antenna pattern to further construct a string of antenna structures, as shown in FIG. 2c. Then, as shown in FIG. 2d, a steel mold, designed for corresponding the distribution of the antenna structures 32, is used to aim at the antenna structures 32 on the roll 20 to proceed the die cutting process, and so as to separate the antenna structures 32 from the electroplating lines 24, 24′, as shown in FIG. 2e, further to obtain a plurality of detached planar antenna structures 32. FIG. 4 is a cross-section diagram illustrating one of the antenna structures 32, wherein every antenna structures 32 includes the roll 20, the antenna pattern 22 and the electroplating layer 30 formed on the roll 20 in order.

Continuously, please refer to FIG. 3, in the present embodiment, the roll 20 having the antenna patterns is transported to the electrolyte by a plurality of roll wheels 36 to proceed the electroplating process. After finishing the electroplating process, the roll 20 having the antenna structures is rolled up by the roll wheels 36 to be away from the electrolyte, and then the next batch of the roll 20 having the antenna patterns is transported to the electrolyte to proceed the electroplating process. The electroplating process is proceeded over and over again, until the electroplating work of the whole bundle of the roll 20 having the antenna patterns is completed.

Wherein, the conductive material applied to the antenna patterns and the conductive pattern is the silver paste, copper paste, aluminum paste or the other conductive paste. The printing method of the antenna patterns and the conductive pattern can be but not limited to the screen printing, imprint, relief printing or the intaglio printing. In the present invention, the forming method of the antenna patterns and the conductive pattern can be the electroless plating process, in which a sensitization process and an activation process are applied to the flexible substrate and then the flexible substrate is soaked in metallic electrolyte to electroplate with the metallic film and get the foregoing antenna patterns and conductive pattern. Furthermore, the common electrolyte is the copper sulfate or the aluminum sulfate. The electrodes, which electrically connect the conductive pattern, are the cathode, and so as to electroplate the antenna patterns with the electroplating layer made of the copper or the aluminum.

On the other hand, in addition to the steel mold, the laser or the grinder can directly used to separate the antenna patterns from the electroplating lines. The roll is still maintained in the individual antenna structures to be used to proceed the following roll-to-roll manufacturing process of the antenna.

In the present invention, the conductive pattern, which is connected with the antenna patterns, is formed along with the antenna patterns, and can be directly taken as the electroplating electrodes, so that all the connected antenna patterns can be electroplated simultaneously by charging the conductive pattern. In this method the additional electrode sticks are not required to be charged to proceed the electroplating process, and so as to decrease the cost of using and cleaning the electrode sticks and further to solve the conventional problem, in which the electrode stick may fail in attaching to the respective antenna pattern if the antenna patterns are too close to each other. Besides, because the conductive pattern is only electrically connected to the edge of every antenna pattern for charging all the antenna patterns without contacting the electroplating surface of every antenna pattern, an uniform electroplating layer can be formed by a continuous electroplating process without especially caring the contacting place between the electrode sticks and the antenna patterns. Compared with the conventional manufacturing process in which the electrode sticks are used, the prevent invention has the advantages of speedy manufacture and mass production.

To sum up, the antenna patterns and the conductive pattern in the present invention are formed simultaneously by the printing or the electroless plating process, and the existing roll-to-roll manufacturing process is cooperated to electroplate the antenna patterns, so that the electroplating work of the whole bundle of the antenna patterns can be completed in a very short time. And then the cutting process is used to obtain a plurality of individual antenna structures to have the advantages of speedy manufacture, mass production and low cost.

Although the present invention has been explained in relation to its preferred embodiment, it is to be understood that other modifications and variation can be made without departing the spirit and scope of the invention as hereafter claimed.

What is claimed is:

1. A manufacturing method of a planar antenna, comprising:
providing a flexible substrate;
forming a plurality of antenna patterns on said flexible substrate and forming a conductive pattern to connect said plurality of antenna patterns, wherein said conductive pattern is connected to an electrode;
soaking said flexible substrate in an electrolyte and simultaneously electroplating said plurality of antenna patterns with an electroplating layer by charging said conductive pattern; and
cutting parts of said flexible substrate to separate said plurality of antenna patterns from said conductive pattern.

2. The manufacturing method of a planar antenna according to claim 1, wherein said conductive pattern comprises a plurality of electroplating lines to respectively connect said plurality of antenna patterns and construct a antenna-pattern string, wherein two terminals of said antenna-pattern string are electrically connected to said electrode by using said electroplating lines.

3. The manufacturing method of a planar antenna according to claim 2, wherein said plurality of antenna patterns and said plurality of electroplating lines are simultaneously formed on said flexible substrate.

4. The manufacturing method of a planar antenna according to claim 3, wherein said plurality of antenna patterns and said plurality of electroplating lines are formed by printing or electroless plating.

5. The manufacturing method of a planar antenna according to claim 4, wherein said plurality of antenna patterns and said plurality of electroplating lines are made of conductive material or conductive paste, and said conductive material or said conductive paste is silver, copper or aluminum.

6. The manufacturing method of a planar antenna according to claim 1, wherein said cutting step is proceeded by steel mold, laser cutting or grinding.

7. The manufacturing method of a planar antenna according to claim 1, wherein said flexible substrate is a roll made of polyester, polyimide or paper.

8. The manufacturing method of a planar antenna according to claim 7, said soaking step includes a roll-to-roll manufacturing step for electroplating said flexible substrate and a rolling-up step for separating said flexible substrate away from said electrolyte.

9. The manufacturing method of a planar antenna according to claim 7, wherein said electrode is a cathode.

10. The manufacturing method of a planar antenna according to claim 1, wherein the material of said electroplating layer is copper or aluminum.
